(19) United States
(12) Patent Application Publication
(10) Pub. No.: US 2012/0183733 A1
(43) Pub. Date: Jul. 19, 2012

(54) MECHANICALLY STABLE COATING

(75) Inventors: Arnaud Tourvieille De Labrouhe, Crissier (CH); Laurent-Dominique Piveteau, Bussigny (CH); Heinrich Hofmann, Pully (CH)

(73) Assignee: Debiotech S.A., Lausanne (CH)

(21) Appl. No.: 13/384,563

(22) PCT Filed: Jul. 14, 2009
(86) PCT No.: PCT/IB2009/053055

§ 371 Date: Mar. 27, 2012

(51) Int. Cl. B32B 15/04; B32B 18/00; B32B 5/16; B05D 7/00; B05D 3/02; B82Y 30/00

(52) U.S. Cl. 428/148; 427/331; 427/372.2; 428/143; 977/773

(57) ABSTRACT

Element comprising a substrate and a nanoporous adherent coating made of at least one layer, said layer being in adherent contact with said substrate and comprising separate domains of nanoparticles, each of said domains having an average diameter between 1 and 1000 nm and being separated from its neighbor domains on the major part of its circumference by an average distance equal or less to its diameter.

### FIELD OF INVENTION

The present invention relates to nanoporous adherent coatings. The coating is made of nanometer size entities having diameters between 1 nm and 1000 nm.

It also relates to a process for fabricating nanoporous adherent coatings containing nanometer size entities. It also relates to a process for fabricating such coatings with a multimodal pore size distribution.

The invention finally relates to objects covered with said coatings.

### STATE OF THE ART

A main concern with a lot of coatings, and especially ceramic coatings, deposited onto various substrates is their brittleness and more generally their mechanical weakness when the substrate is elastically or plastically deformed. When a coating is deposited onto a metallic substrate and that this substrate is deformed, cracks will form within the coating and after further deformation, delamination will occur. This dramatic process occurs when the stress forces that are forming at the interface between the substrate and the coating overcome the adhesion strength resulting in a separation of the two components.

Different approaches have been used to minimize this effect. Porous ceramics have been created or very thin films have been deposited.

### GENERAL DESCRIPTION OF THE INVENTION

The present invention relates to an element comprising a substrate and a nanoporous adherent coating made of at least one layer, said layer being in adherent contact with said substrate and comprising separate domains of nanoparticles, each of said domains having an average diameter between 1 and 1000 nm and being separated from its neighbor domains on the major part of its circumference by an average distance equal or less to its diameter.

In the present application the term “domain” means a region of coating, made of at least one nanoparticle, which is in direct contact with the substrate surface. A domain can be completely separated from other domains, i.e. without any contact with other domains. It may also be in contact with other domains, but in that case the area of contact is limited in volume and clearly differentiable from the domains themselves.

For the above reasons, in the present application the terms “separate” or “separated” have to be understood as “mainly separated”.

The term “cluster” refers to another object, different from a domain, which is made of at least one nanoparticle and which is not in contact with the substrate surface.

In a possible embodiment this element is obtained by the following process:
providing a substrate
depositing on said substrate said coating from a suspension containing nanoparticles with an average diameter between 1 and 500 nm characterized by the fact that it contains at least a binding agent that will be eliminated during the fixating treatment.
applying a fixating treatment

Advantageously this fixating treatment is a heat treatment that preferably is characterized by the fact that it is split into at least two sub-treatments, one being conducted in an oxidizing atmosphere in order to burn organic components and another one being conducted in an inert or reducing atmosphere to increase the adhesion and to consolidate (sinter) the material.

In another possible embodiment, this element is obtained by the following process:
providing a substrate
depositing on said substrate a temporary template layer
depositing on said substrate said coating from a suspension containing nanoparticles with an average diameter between 1 and 500 nm characterized by the fact that it contains a binding agent that will be eliminated during the fixating treatment.
applying a fixating treatment

Advantageously this fixating treatment is a heat treatment that preferably is characterized by the fact that it is split into at least two sub-treatments, one being conducted in an oxidizing atmosphere in order to burn organic components and another one being conducted in an inert or reducing atmosphere to increase the adhesion and to consolidate (sinter) the material.

The latter approach is an example of how to produce such coatings with multimodal pore distribution. The template layer is used to create larger pores than the nanoporosity created by the nano-particles themselves.

In a possible embodiment, the particles that are used to create such coating have average diameters between 1 and 100 nanometers.

In a possible embodiment, the domains of coating present in at least the first layer have an average diameter between 100 and 500 nm.

In a possible embodiment, the average distance separating two neighbor domains of coating is between 20 and 200 nm.

In a preferred embodiment, the average diameter of domains of coating will be five times larger than the average distance between two neighbor domains of coating.

In a possible embodiment, the substrate is a ceramic. In another possible embodiment the substrate is a polymer. In a preferred embodiment the substrate is a metal.

In a possible embodiment, the coating is made of a metal. In another possible embodiment the coating is made of polymer. In a preferred embodiment the coating is made of a ceramic. In another possible embodiment the coating is made of a mixture of at least to of the preceding elements.

In a possible embodiment, the domains of coating are themselves nanoparticles obtained by sintering and/or fusion of several smaller nanoparticles.

In a possible embodiment, last two steps of the process (nanoparticles deposition and heat treatment) are repeated at least once during the manufacturing process. With this approach, it is possible to create thick coating with layers of different porosities. In particular, the upper layers may be constructed with nanoparticles or nanoparticle clusters having different diameters that those of the domains present in the first layer.

In a possible embodiment, the binding agent represents at least 5% in mass of the suspension. In another embodiment, the binding agent represents at least 25% in volume of the suspension.

In a possible embodiment the binding agent is a polymer. In a preferred embodiment the polymer is chosen in the group of Polyacrylate, Polyvinyl alcohol, Polyethylenglycol, PMMA.

In a possible embodiment, the substrate is a metal and the heat treatment step corresponds to the annealing of the substrate. For example, the processing of a coronary stent contains several steps. A metallic tube is cut by laser, annealed to relax stresses accumulated by the former treatment and then electropolished to clean and smooth the surface. In this invention we described a process to coat a substrate having a heat treatment step. In the present embodiment, the annealing step and the coating heat treatment step may be combined in a single heat treatment step.

In a possible embodiment, the heat sub-treatment conducted in an oxidizing atmosphere is used to burn organic components and the heat sub-treatment conducted in an inert or reducing atmosphere is used to sinter the material.

In a preferred embodiment, the inert atmosphere has a maximum partial pressure of oxidizing gas of 10⁻¹⁴ bar. This maximal partial pressure may change according to the material present in the coating as well as the sintering temperature. This value is the partial pressure of oxygen with titanium at a temperature of 800° C. If the oxygen partial pressure is higher, titanium will start to oxidize. In a possible embodiment, the heat treatment will be conducted in a sealed container with controlled atmosphere. In another possible embodiment, the sealed container will contain a piece of titanium. This piece of titanium will act as a sort of oxygen pump, maintaining its partial pressure below 10⁻¹⁴ bar. In another possible embodiment, this titanium piece will be placed in a region of the container where the temperature is slightly lower than the temperature of the element being sintered. In this way, the gas present, that may contain traces of oxygen, will move by convection from the sample to the titanium.

In a possible embodiment the heat treatment conducted in an oxidizing atmosphere is done at a temperature between 300° C. and 600° C. In maintaining the temperature within this range, it is possible to burn the organic components used during the coating procedure without, or with minimally, oxidizing the substrate.

In a possible embodiment the heat treatment conducted in an inert or reducing atmosphere is done at a temperature above 500° C.

In another possible embodiment the heat treatment conducted in an inert or reducing atmosphere is done at a temperature below 1000° C.

In a preferred embodiment the temperature is maintained between these two temperatures.

In a preferred embodiment the inert atmosphere is made of a gas or a mixture of gas selected from the following list: argon, helium, nitrogen, formiergas, and hydrogen.

The effectiveness of a coating is conditioned by its mechanical resistance. This resistance combines the adhesion of the coating to the surface and its cohesion. When deformed, the two principal modes of degradation of a coating are crack formation preferentially perpendicular to the substrate surface and the applied stresses and delamination (crack formation in the same plane as the interface substrate/coating). The presence of cracks perpendicular to the substrate does not necessarily affect the effectiveness of a coating. However, when delamination is initiated, the coherence of the coating starts to be lost. Some regions initially coated become exposed, and some parts of the coating are released into the environment.

If we consider a thin, hard and relatively fragile coating on a thick and ductile substrate, when this coating—substrate system is subject to an external force, for example a traction force, it will, in a first step, deform in an elastic way. As the Young modulus of the ceramic coating is much higher than that of the substrate, at a certain point of time, i.e. for a given critical strain, a first crack will form within the coating; a crack perpendicular to the surface of the substrate. This crack will form when a given stress, the so-called critical stress, is reached within the coating. As soon as this crack appears, the stress will disappear within the coating in the vicinity of the crack, but it will generate a stress concentration at the lower extremity of the crack, at the coating—substrate interface. This stress concentration may induce, if the adhesion force is low, a delamination of the coating, and if the substrate is ductile, the formation of a zone of high plastic deformation. The starting point of delamination will depend on the adhesion of the coating to the substrate. The more this adhesion is pronounced, the more delamination will be delayed.

When a crack is formed, the stress within the coating drops to zero in the vicinity of the crack. As one moves away from the crack, the stress increases again. If the strain is large enough and if the distance to the crack is long enough, the stress can reach the critical stress value, high enough to initiate the creation of another crack. The cracks are formed to allow the relaxation of the stress which appears within the coating when the substrate is deformed. If, once a crack is formed, the deformation continues, the stress will grow until a new crack is formed. There is a certain zone around each crack in which the probability of seeing another crack being formed is equal to zero (i.e. the distance to the crack is to short for the stress to reach its critical value). Moreover, if the film shows a not too high strength and if the deformation of the substrate is in the plastic range, then the size of this zone is independent of the lateral shear stress induced by the deformation at the substrate—coating interface as well as of the number of already existing cracks. In the case of nanostructured coatings on metallic substrates and for deformations making sense in the industry such conditions are fulfilled. There is therefore a minimal distance I₀ between two cracks. Beyond, if the deformation continues, the number of cracks will not increase. It can therefore be deducted that in a zone extending on ±I₀/2 around the crack, the lateral shear stress at the interface between the substrate and the coating cannot generate a stress that would exceed the within the coating critical stress and could lead to delamination.

The deformation of a substrate by traction involves on its surface two types of deformations: surface elongation and surface contraction. If a force is applied to a coated substrate to stretch it, the surface deformation of the substrate and of the coating along the axis parallel to that force will be a traction. The deformation in the plan perpendicular to the force axe will be a surface contraction (if the Poisson modulus of the substrate is lower than that of the coating. If the Poisson modulus of the coating is higher, the coating will undergo a traction). This surface contraction will not be as pronounced as the traction: for example for a substrate of cylindrical section, it will roughly represent a third (elastic deformation) to half (plastic deformation) of the deformation in elongation. Contrary to elongation deformations, the impact of a deformation in compression in a coating cannot be compensated by the formation of cracks. One way to compensate for this deformation is to create in advance structures such as cavities or cracks perpendicular to the contraction direction within the coating before it is deformed. During the deformation these structured will be crushed and will enable to maintain the coherence of the coating.

In the coatings as described in this invention, the ceramic layer is already fissured in a controlled way in all directions. Indeed, a structure presenting the form of small domains guarantees the presence of artificial cracks in all directions. The distance between these cracks, or in other words the “diameter” of these domains, is lower than l₀. This means that the stress within the coating remains below the critical stress on the whole surface of each domain, independently of the deformation and of the rest of the coating. The value of this I₀ depends from the ratio adhesion strengths/cohesion strengths and has been experimentally determined for cases presented in this invention. It depends on the coating production parameters but it has values between 700 nm and 1000 nm. The graphs FIG. 7a) and FIG. 7b) as well as the photographs of FIGS. 8a) and 8b) clearly show a saturation of the number of cracks for densities between 1000 and 1400 cracks per millimetre, that is a distance between 700 nm and 1 micrometer.

### DETAILED DESCRIPTION OF THE INVENTION

In one possible embodiment of this innovation, the coating is obtained by depositing nanoparticles from a suspension onto a substrate. The coating can therefore be seen as a random stacking of domains, particles and clusters connected to each others by small necks (See FIG. 6 for a schematic view and FIGS. 10a) and 10b) for micrographs). The suspension that is used is a mixture of nanoparticles, a polymeric binder and a solvent. In order to maintain the stability of the solution, and avoid flocculation or aggregate formation, one can add a stabilizing agent such as for example a base.

When this mixture is deposited onto the substrate, some parts of the substrate will be in contact with particles while other parts will be covered by polymer. The surface ratio between these two parts of the substrate will be, a priori, related to the relative concentrations of particles and polymer into the suspension. On top of this “first” layer, other particle layers will be stacking in a random way.

When the heat treatment is applied, the configuration evolves. In the case of two sequential treatments, when one is conducted in air and the other one in pure argon (oxidizing and neutral atmospheres respectively), the polymer will first “burn” creating some void spaces. Then the particles will start to sinter together by forming necks at the contact points of the particles and create larger entities (this is the sintering or consolidation process). If this process is conducted under controlled conditions of time and temperature, this consolidation process will not go up to the formation of a dense layer on the substrate and the final layer will look similar to the schematics shown in FIG. 6. A first layer of coating domains (1) is in contact with a substrate (2). These domains, depending on the starting material as well as on the heat treatment parameters will have variable average diameters. The minimal possible diameter will be given by the diameter of the nanoparticles used in the suspension. The maximal diameter will be maintained under 1000 nm, in order to guarantee good adhesion of the coating to the substrate. The value of this length has been discussed above. On top of this first layer, a series of layers will pile up to form the coating. The elements—nanoparticles or clusters—(3) forming these additional layers are not in direct contact with the substrate. There are in contact with other elements, from the first layer—domains—and or from other layers—nanoparticles or clusters—. The contact points (4) are small neck whose diameter is much smaller than the average diameter of the element.

If we look from the top at the first layer of coating, we can see domains (1) with different configurations. FIGS. 5a) and 5b), show two possibilities. In FIG. 5a) the domains are not in contact with each other. They are all separated from their neighbor by a sort of groove. FIG. 5b) shows another possible embodiment where the domains are separated on most of their circumference from their neighbor by sort of grooves. They are in contact with some neighbor domains through small necks whose diameters, in this example, are much smaller than the average diameter of the coating domains.

In the description above we mentioned the use of a particle suspension to create the coating. This isn't obviously a limiting example. The same type of coating can be obtained by other wet chemical routes such as but not limited to sol-gel, precipitation, electro-deposition, spraying and a combination thereof but it can also be obtained by non wet chemical routes such as for example but not limited to sputtering, spraying or plasma spraying, PDV, CVD or a combination thereof.

An important property of the coating described in this invention is their very high mechanical adhesion. When for example a ceramic is deposited onto a metallic substrate, and when the substrate is deformed, either by traction or by compression, very quickly the coating will delaminate. The processes explaining this behavior are well described in several scientific publications. A typical example of such behavior is shown on FIG. 4. Here a relatively thin coating (about 1 micron) of titanium dioxide has been deposited onto a stainless steel wire. It has been sintered and densified at 850° C. The wire was then bent, generating a surface strain of about 40%. In the FIG. 4, one can clearly distinguish three zones. On the left (i.e. on the concave side of the bended wire) the coating is under compression. On the right (i.e. on the convex side of the bended wire) the coating is under traction. In the intermediate zone, the substrate hasn't been strained. In both regions where the substrate has been deformed, the coating shows dramatic signs of delamination. Pieces of the coating have been partially of totally removed form the substrate.

On the contrary, FIGS. 1 to 3 show a coating as described in this innovation. Here again a stainless steel wire has been coated with a micrometer thick layer of titanium dioxide. Here again the substrate has been bended until a surface strain of about 40% has been reached. FIG. 1 shows a global view of the wire. FIGS. 2 and 3 are enlargement of the elongated respectively the compressed region (corresponding to the top, respectively to the bottom of the wire on FIG. 1). On both figures, one can see that the coating adheres to the substrate and has maintained its coherence. One can also see the deformation of the substrate, where the grains have slipped against each other, which have been transmitted to the coating.

FIGS. 10a) and b) are another example of this property. Here a titanium dioxide layer of about 400 nm has been deposited onto a stainless steel substrate. The sample was then elongated creating a surface strain of more than 30%. The two figures show a cross section of the coating after deformation. The elongation was done in the plan of the picture. One can clearly distinguish the domains of coating as described in the claims, in contact with the substrate. One can also clearly see the different features mentioned in FIG. 6: on top of these domains, nanoparticles or clusters are piled up in a random way and are interconnected to each other through necks. One can see quite well in FIG. 10b) that the domains of coating, having diameters below 400 nm, are adhering to the substrate.

General Coating Process

The following is a description of some possible variants of the processes used to obtain such adhesive coatings.

A first embodiment of the coating process comprises the following steps:
1) a support or substrate having a surface is provided
2) a coating is deposited onto this substrate from a suspension. This suspension contains at least nanoparticles and a binding agent that will be eliminated during the fixating treatment.
3) a fixating treatment is then applied

Advantageously, the fixating treatment is a heat treatment that preferably is characterized by the fact that it is split into two sub-treatments, one being conducted in air (an oxidizing atmosphere) and another one being conducted in argon (an inert atmosphere).

In another possible embodiment, a temporary template layer is deposited before the coating is deposited onto the substrate. This temporary template layer will be removed during the heat treatment. It is structured in such a way that by its removal it will generate cavities in the coating.

In a third possible embodiment, the temporary layer is deposited after a first layer of suspension has been deposited.

In a fourth possible embodiment, the process as described in the first embodiment (step 1 to 3) is conducted. The last two steps (2 and 3) are then repeated a second time. In this embodiment, the mixture used for the “first” step 2 may be different than the mixture used for the “second” step 2. In particular, nanoparticles of different diameters can be used.

In a fifth embodiment, the template layer may be deposited after completion of the process as described in the first embodiment. Once the template layer is deposited, another coating is deposited onto the coating and a new heat treatment is applied.

Coating Deposition: Precursors

Different procedures can be considered for the coating deposition. They are chosen according to the coating precursors that are used as well as to the desired properties of the coating. A few examples of precursors for wet chemical methods are given below:

In a first type of embodiment one can use a suspension of nanoparticles (or a nanopowder) in a solvent such as for example water. In a preferred embodiment, this suspension contains also a binding agent, such as for example a polymer. This binding agent has potentially different impacts. During the coating procedure, it can allow the production of a thicker layer. When depositing a layer from a liquid precursor on a surface, it is well known that the evaporation of the solvent may create uncontrolled fissuration in the layer. One well documented approach to avoid this type of behavior is to add a binding agent to the solution. This agent may also have an impact on the formation of coating domains. By changing the concentration of this agent in the starting suspension, one changes the density and disposition of nanoparticles in contact with the substrate that will be used to generate these domains. Variations in densities and dispositions may favor different types of concentrations during sintering.

In another embodiment, the suspension can be stabilized using for example a base. The role of the stabilizer (acting for example by changing the surface charge of the particles, or as a chelating agent) is to avoid the formation of uncontrolled aggregates of particles.

In another embodiment, one can use a sol obtained through hydroxylation and partial condensation of a metallic alkoxyde as coating precursor.

In another embodiment, the precursor can be a solution obtained by dissolving a precursor into the adapted solvent.

In the both embodiments described above, sol and solution, one can add a binding agent and/or a stabilizing agent.

In another embodiment, one can combine several binding agents. This combination can lead to new properties, such as for example when two polymers are used together giving more adapted mechanical and thermal properties, or complementary properties.

In a given embodiment the precursor used can be a hydrophilic material and therefore generate hydrophilic coating surface.

In another embodiment the precursor used can be a hydrophobic material and therefore generate hydrophobic coating surface.

In another possible embodiment, one can use a first category of precursor for the first layer and a second category of precursor for the additional layer. For example, the first layer, or possibly the first few layers, is obtained using a nanoparticles suspension as precursor. Such precursor may be more favorable for the constitution of a certain type of domains. Then, the upper layers are obtained using a sol-gel route. It is known from the literature that the porosity of layers produced using a sol-gel route may be significantly different to those produced using a nanoparticles suspension.

Using nanopowders or a sol-gel approach for producing coatings offers the advantage of reducing the necessary temperature for obtaining crystalline coatings. This is particularly favorable for metallic substrates that may go through phase transitions when thermally treated and therefore lose part of their mechanical or shape memory properties.

Coating Procedure: Deposition Method

In a first possible embodiment, the precursor is deposited by dip coating. The sample is immersed (fully or partially) into the precursor; it is then pulled out of the precursor at a constant and controlled speed. The thickness of the coating varies, among others, with the viscosity of the mixture and with the pulling speed.

In a possible embodiment, the dipping procedure will be repeated several times. Each dipping will allow the deposition of an additional layer onto the substrate. In a possible embodiment, one can change the composition of the precursor between dipping. The change may concern some physical properties of the precursor (such as for example the size of the nanoparticles or the nanoparticles vs. binding agent ratio in the case of a nanoparticles suspension) or the chemistry of the solution. By changing the chemistry of the precursor between each step, it is possible to create coatings having a chemical gradient. In a possible embodiment, on can start with a precursor having the same composition than the substrate and change this composition over the thickness of the coating.

In another possible embodiment, the precursor is deposited by spin coating. A drop of precursor is deposited onto the surface to be coated. This surface is rotated at a very high speed, spreading the drop on the surface due to centrifugal forces. The thickness of the coating varies, among others, with the viscosity and the angular speed.

As for dip coating, the process can be repeated several time, and as for dip coating the precursor can be changed in between.

In another possible embodiment, the precursor is applied to the surface by electrodeposition. Here an electrical potential is applied that will transport the coating elements from the precursor to the surface.

As for dip and spin coatings, the process can be repeated several time, and as for dip and spin coatings the precursor can be changed in between.

In a fourth possible embodiment, the coating is deposited by ink-jet printing. There are different types of ink-jet printing technologies available today. As an example we describe hereafter the drop-on-demand technology (but this description can easily be extended to continuous ink-jet printing). In the drop-on-demand technology, micro-droplets of a substance are projected at the request of the operator through a nozzle onto a surface. The nozzle and/or the surface can be moved in all spatial directions (for example x, y, z, or r, θ, z, more adapted to cylindrical systems such as stents). This movement allows a precise control on the final localization of the droplet on the surface. Ink-jet offers a perfect spatial control of the drop deposition. Spatial resolution of the inkjet method is, as of today, of the order of a few micrometers.

In a possible embodiment, ceramics with various compositions and porosities can be coated on different parts of the substrate. Compared to the other methods presented above, ink-jet offers the flexibility in all directions. It is possible, as for dip and spin coating as well as for electrodeposition to create variations in the thickness of the coating. With ink-jet it is also possible to integrate, at a micrometer level, variations in composition in the x and y directions. In a possible embodiment, one can have a coating having a given chemical composition in a region, and a completely different chemical composition in another region. The same can be true for physical properties of the coating. Similar structure could be obtained with the other methods described above. For example, this could also be achievable with dip coating by using a smart masking strategy of the surface. This result can be obtained in a very simple way by ink-jet.

As mentioned above, the coating procedure can be repeated several times. This allows modifying the composition of the coating but also, as another example, this allows creating thicker coatings. It is well know from the art that, for coatings obtained via wet chemical routes, over a certain thickness, cracks start to form during the evaporation of the solvent. As a direct consequence, this limits the thickness of crack-free films that can be deposited. As mentioned before, the use of a binding agent may, under certain circumstances permit the creation of thicker layers. Another approach is to repeat the process several times. Between each coating deposition, the previous layers can be dried or fully sintered.

Coating Containing Cavities

In possible embodiments, the coating can have multimodal porosities. Various methods to create these types of porosities have been used and described (see Piveteau, Hofmann and Neftel: “Anisotropic Nanoporous Coating”, WO 2007/148 240 as well as Tourvieille de Labrouhe, Hofmann and Piveteau: “Controlling the Porosity in an Anisotropic Coating”, PCT/IB2009/052206 and their related documents.). They can be applied to this innovation.

In a possible embodiment, the ceramic nanoporous coating is obtained by the following process:
a support or substrate having a surface is provided
a temporary template layer is deposited onto this support or substrate
the combination of the support or substrate and the template layer is covered by a coating obtained from a suspension containing at least nanoparticles and a binding agent that will be eliminated during the fixating treatment.
applying a fixating treatment

Advantageously, this fixation treatment is a heat treatment that preferably is split into at least two sub-treatments, one being conducted in an oxidizing atmosphere and another one being conducted in a neutral or reducing atmosphere.

In another possible embodiment, the coating process comprises the following steps:
a support or substrate having a surface is provided
a temporary template layer is deposited onto the support
the template layer is structured. In a possible embodiment this structuration is done by directly irradiating the layer with, for example, an electron beam or a laser beam. This irradiation will change the solubility properties of selected regions of the template layer. In another possible embodiment an additional mask is used to protect some parts of the template layer during the irradiation. The irradiated regions are then removed.
the resulting support of substrate covered with a structured template layer is covered by a coating obtained from a suspension containing at least nanoparticles and a binding agent that will be eliminated during the fixating treatment.
a fixating treatment is applied

Advantageously this fixating treatment is a heat treatment that preferably is split into at least two sub-treatments, one being conducted in an oxidizing atmosphere and another one being conducted in a neutral or reducing atmosphere.

Thermal Treatment

The thermal treatment that we use during the manufacturing has, among others, two potentially important roles: it is first used to eliminate every organic compound that may have been used for the coating deposition or that may be present in the coating. It is also used to sinter the ceramic. Sintering is a process where ceramic particles form necks and grain boundaries, reduces the porosity and in a final stage form dense bodies, all by solid state diffusion processes. This will modify and improve the mechanical properties of the material.

In a possible embodiment, the thermal treatment is split into two sub-treatments.

The first treatment is done under an oxidizing atmosphere. In a preferred embodiment the temperature will be set between 300° C. and 600° C. A typical oxidizing atmosphere that can be used is air. The objective here is to burn all organic compounds. This typically occurs in the 300° C. to 600° C. region. The objective is to choose a temperature that is high enough to burn all organic molecules. At the same time, when using metal as substrate, it should not be too high to limit the oxidation of the substrate. The ideal temperature for a given system can be determined by a thermogravimetric analysis. In this type of analysis, a sample is heated up and its weight is measured. When organic compounds are burned, a sharp drop in the weight of the sample can be observed. The treatment temperature shall be set just above this limit.

The second treatment can be conducted in an inert or slightly reducing atmosphere. Here the objective is to avoid the oxidation of the substrate. Different gases or a mixture of them may be chosen. A possible and non exhaustive list is: argon, helium, nitrogen, formiergas or hydrogen.

In a possible embodiment one can conduct this treatment with the sample being sealed into a container. The atmosphere has then to be controlled in this container only.

In another possible embodiment, one can add into the oven (or into the container) an element that will absorb traces of oxygen that may be present. At temperatures used for sintering, surface oxidation is strongly accelerated and only very low concentrations of oxygen are necessary. Adding an element that will act as an oxygen trap into the oven (or into the container) where the sample is placed can eliminate potential traces of this gas. In a possible embodiment, this trap is made of a titanium sponge. In a preferred embodiment, this trap will be placed in the oven (or in the container) in a place where the temperature is slightly below the temperature of the sample that is treated. In this way, oxygen will flow from the sample toward the trap by convection.

In a possible embodiment, the temperature of this sub-treatment will be chosen above 500° C. In a preferred embodiment this temperature will be maintained below 1000° C. Sintering is a procedure that is commonly conducted at temperatures above 1200° C. These temperatures are necessary to allow the consolidation and further densification by diffusion in a technological interesting time frame. It is however well known from the scientific literature that ceramics obtained from nanopowders or by sol-gel route can be sintered at much lower temperatures. Sintering may start at temperatures as low as 500° C. Working with lower temperatures is preferable as this has as a side effect less impact on the substrate.

### LIST OF FIGURES

FIG. 1: Micrograph of a stainless steel wire coated with a layer as described in the invention after deformation.

FIG. 2: Micrograph of a stainless steel wire coated with a layer as described in the invention after deformation: enlargement of the elongation region.

FIG. 3: Micrograph of a stainless steel wire coated with a layer as described in the invention after deformation: enlargement of the contraction region.

FIG. 4: Micrograph of a stainless steel wire coated with a dense layer after deformation.

FIGS. 5a) and b): Schematic drawing of the first layer of a possible embodiment of the coating showing the domains and the separations.

FIG. 6: Schematic drawing showing a possible cross section of the coating.

FIGS. 7a) and b): Top view micrographs of a strained coating showing a) the first layer of a possible embodiment of the coating with the domains and the separations and b) a possible embodiment of the coating.

FIGS. 8a) and b): Graph showing the crack density as a function of substrate deformation for two different coatings on stainless steel.

FIGS. 9a) and b): Micrographs showing the surface of two dense coatings after strong deformation.

FIGS. 10a) and b): Cross section of a coating after substrate deformation.

### APPLICATION

This type of coating can be applied to various fields of the industry, wherever an adherent and stable coating is needed. In a possible embodiment, the material used is ceramic. Ceramic is well known for its protective behavior against, for example, corrosion or wear. This coating can be used in gas turbine blades, heating elements, tools . . . .

Another important application for ceramic coating is the medical field. Its can be used on several objects, medical devices and more specifically, but not limited to, medical implants. In this specific area several ceramics, such as for example titanium oxide, zirconium oxide, calcium phosphate under its different forms, aluminum oxide, iridium oxide, . . . have been identified for their biocompatibility. Some of them are considered to be bioinert i.e. allow a quiet coexistence of the implant with the living tissue, while others are bioactive and favor the growth of new tissue.

Of particular interest are stents, orthopedic, spine, maxillo-facial, osteosynthesis and dental implants. For these specific applications, the coating can be used to improve their resistance to wear, such as for example in implants with moving parts, or to corrosion. The coating is of particular interest for implants that will encounter mechanical deformation during their lifetime.

In one series of possible embodiments, the coating can also be applied to drug eluting implants. In that case, the porosity of the coating, either a purely nano-sized porosity or a porosity combining micro and nano sized cavities, can be loaded with one or several drugs. Here the porosity is used as a drug reservoir that will release its content in a controlled way over time. The reservoirs can be loaded with one or several substances.

For implants such as stents, the coating can be loaded with a combination of the following drugs given as non-exclusive examples: anti-proliferative agents, anti-coagulation substances, anti-infectious substances, bacteriostatic substances . . . .

For implants such as orthopedic, spine, osteosynthesis or dental implants, the coating can be loaded with a combination of the following drugs given as non-exclusive examples: anti-infectious substances, growth factors . . . .

In another possible series of embodiments the porosity can be used to favor tissue ingrowth and therefore increase the mechanical interlocking between the implant and the living tissue. This may be reached by loading the porosity with resorbable bioactive ceramics such as calcium phosphates

In another possible series of embodiments the coating doesn't need to be uniformly deposited onto the substrate. It can cover some regions of the substrate while leaving uncovered some other regions.

Accordingly the support can be made of metal, of ceramic or polymer. It can also be made of a biodegradable material.

### EXAMPLE

Fully annealed 316L wires with a diameter of 300 micrometers and a typical length of 50 mm are electropolished for 5 minutes in an electrochemical cell. The electrolyte is composed of phosphoric acid 35% wt, deionized water 15% wt and 50% wt of glycerol. The solution is stirred with a strong magnetic stirrer and heated up to 90° C. Metallic substrates are dipped into the solution and a current density of 0.75 A/cm² is applied to the system. The distance between electrode and sample is fixed to 50 mm.

Once, samples are electropolished, they are rinsed with three successive ultra-sonic baths of 5 minutes: soap plus water, acetone and ethanol. Then, they are dried in an atmospheric chamber for 10 minutes at 37° C. and 10% relative humidity.

After, samples are coated with the nano-structured ceramic coating. To do so, samples are clamped on a dip coater and then dipped into a ceramic suspension. They are withdrawn at a speed of 300 mm/min and dried for 10 minutes in an atmospheric chamber at 37° C. and 10% relative humidity.

The ceramic suspension is made with 100% anatase TiO₂ powder (7.3% wt), Polyvinyl acetate (7.5% wt), deionized water and ammoniac. Ceramic particles are composed of a few agglomerated mono-nanoparticles. The mean size of these elements is d_{med}=24 nm, whereas aggregate size dispersion is described by d₁₀=32 nm, d₅₀=46 nm, d₉₀=61 nm. The powder specific surface area was measured to be 65.7 m²/g. To the initial ceramic suspension, a polymeric binder is mixed to act on the colloidal stability and to create porosity in the ceramic coating. The polymer is Polyvinyl acetate 3-96, also commonly called Mowiol 3-96. To be mixed with TiO₂ suspension, it is previously dissolved in deionized water by heating the solution to 90° C. for 1 h under a strong magnetic stirring. Finally, to enhance the colloidal stability, ammoniac is used to fix the pH in the solution at 10.5.

Then, the coated sample is heat-treated in a controlled atmosphere to avoid substrate oxidation. It consisted of two successive steps: 1) a debinding step at 420° C. for 1 h in air, aimed at removing residual organic solvents molecules as well as binder present in the green coating; 2) a consolidation step at 820° C. for 0.5 h, where surrounding gas was controlled in order to avoid sample oxidation. To do so, before the second thermal treatment, samples were encapsulated in a quartz capsule with 300 mBar of argon and a titanium sponge. Thermal rate for coolings and heatings were equal to 5° C./min.

### DETAILED DESCRIPTION OF THE FIGURES

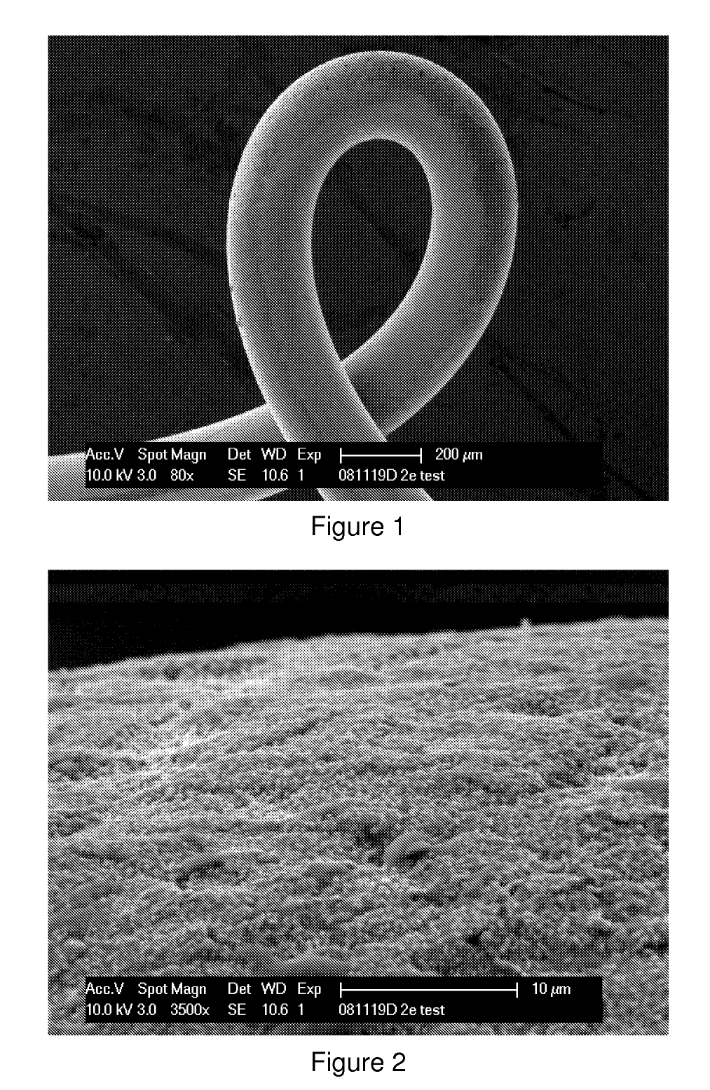

FIG. 1 shows a micrograph of a stainless steel wire of round section covered with a titanium dioxide coating. The system was deformed by bending. The surface strain created by this deformation attains 40%. As can be seen on the picture, no delamination occurred. The coating has a thickness of about 1 micrometer.

FIG. 2 shows an enlargement of the upper part of the coated wire shown in FIG. 1. It shows the region under traction. The deformation of the substrate can be observed. The grains have slipped against each others creating a new rougher surface. One can also clearly see that the coating has not delaminated. It still adheres to the substrate.

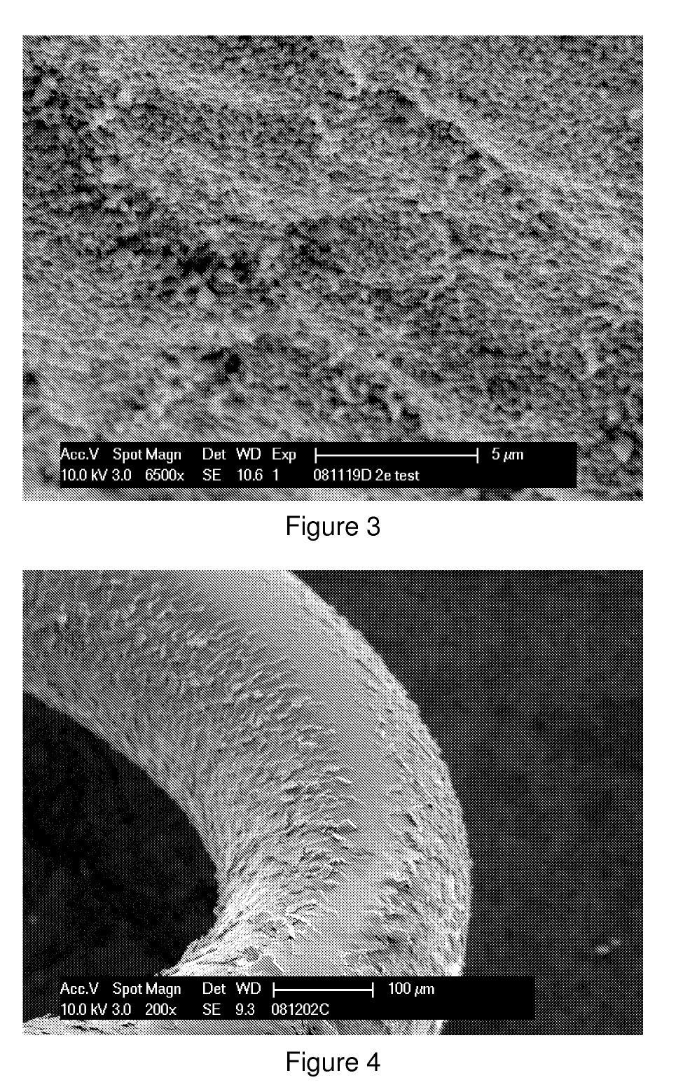

FIG. 3 shows an enlargement of the lower part of the coated wire show in FIG. 1. It shows the regions under compression. Here again the deformation of the substrate can be observed. And again one can see that the coating has not delaminated. It has maintained its adhesion to the substrate as well as it coherence.

FIG. 4 shows a micrograph of a stainless steel wire of round section covered with a classical titanium dioxide coating of about 1 micrometer in thickness. As in FIG. 1, the system was deformed by bending. One can see distinct regions. On the left, the coating is under compression, on the right it is under traction, while in the middle it doesn't undergo any strain. In both deformed regions, one can clearly observe the delamination of the coating.

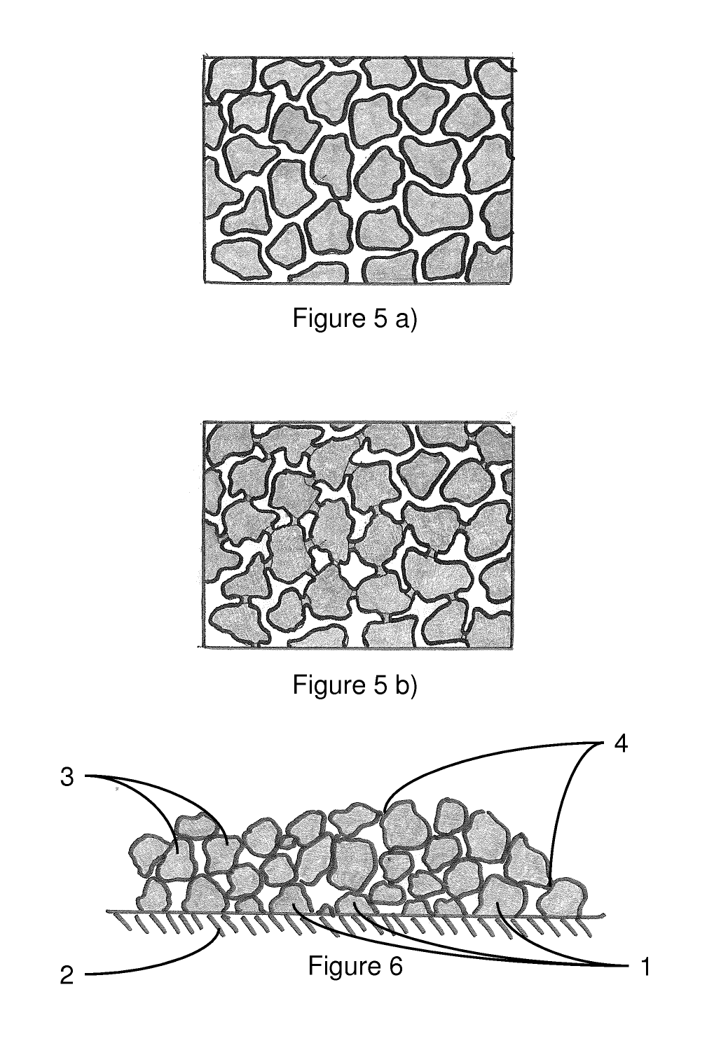

FIG. 5a) is a schematic of a possible embodiment of the first layer of the coating. Domains of coating having average diameters below 1000 nm are surrounded by sorts of grooves.

FIG. 5b) is a schematic of a possible embodiment of the first layer of the coating. Here, the domains of coating, having diameters below 1000 nm, are separated from other domains on the major part of their circumferences.

FIG. 6 is a schematic of the cross section of a possible embodiment of the coating. On a substrate (2) we can distinguish several layers of domains and particles and clusters. The first layer is made of domains (1) in contact with the substrate. These domains have average diameters under 1000 nm. Their thickness may be smaller than their diameter. On top of the first layer, one can see several layers of particles or clusters (3). These particles or clusters are piled up in a random way. Their average diameter may be similar to the diameter of the domains, but it may be different. The contact points are small necks.

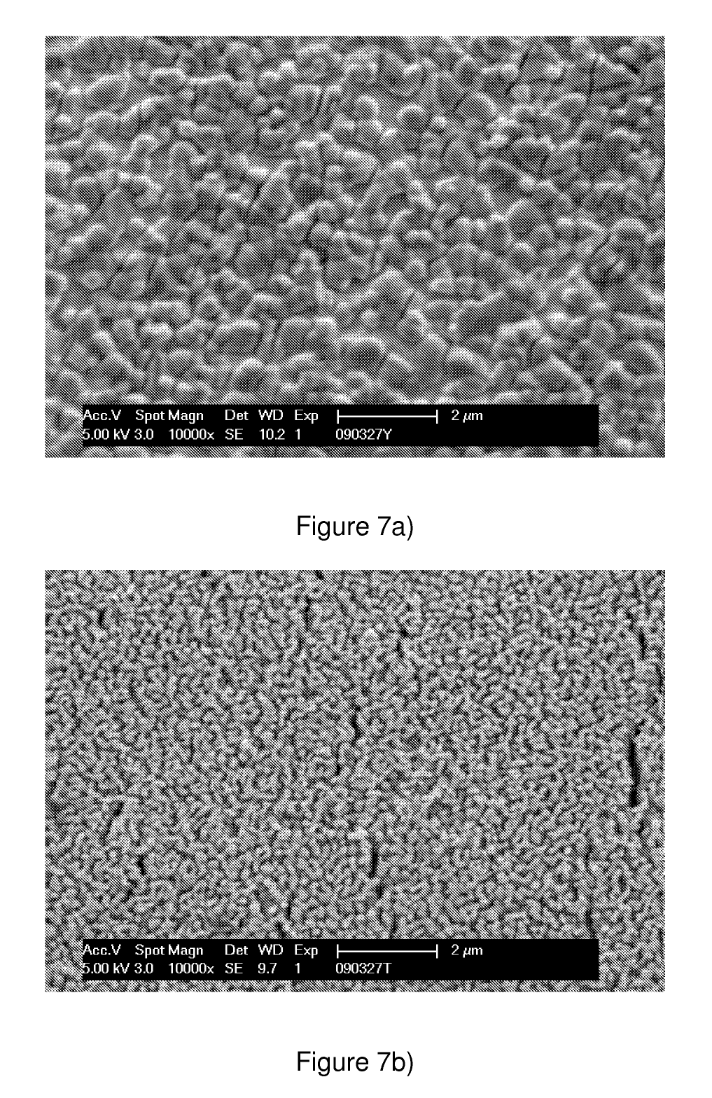

FIG. 7a) and FIG. 7) show top-view micrographs of a possible embodiment of the coating after deformation (approx. 30%). FIG. 7a) shows the first layer. One can distinguish the domains separated from each other on most of their circumference. One can also see the cracks created by the strain of the substrate. FIG. 7b) shows a coating made of several layers. One can also distinguish some cracks coming from the strain of the substrate. No delamination has occurred.

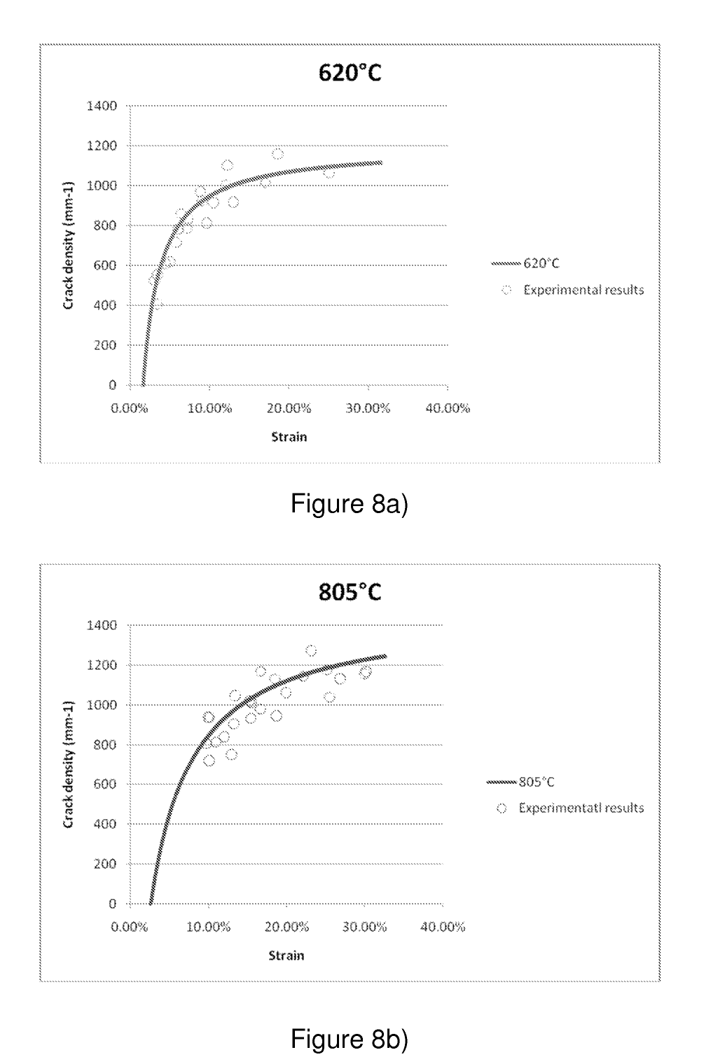

FIG. 8a) and FIG. 8b) show two plots of the crack density in a coating as a function of the stress applied to the substrate. These plots are obtained using the fragmentation method. The density of crack increases with the strain, as this is a way for the coating to release internal stress. When delamination occurs, no more cracks are formed. This transition corresponds to the plateau than can clearly be observed on the graphs. For the sample treated at 620° C., delamination starts for strains around 5%. The samples treated at 805° C. shows a better adhesion of the substrate. Delamination starts at strains of about 10%.

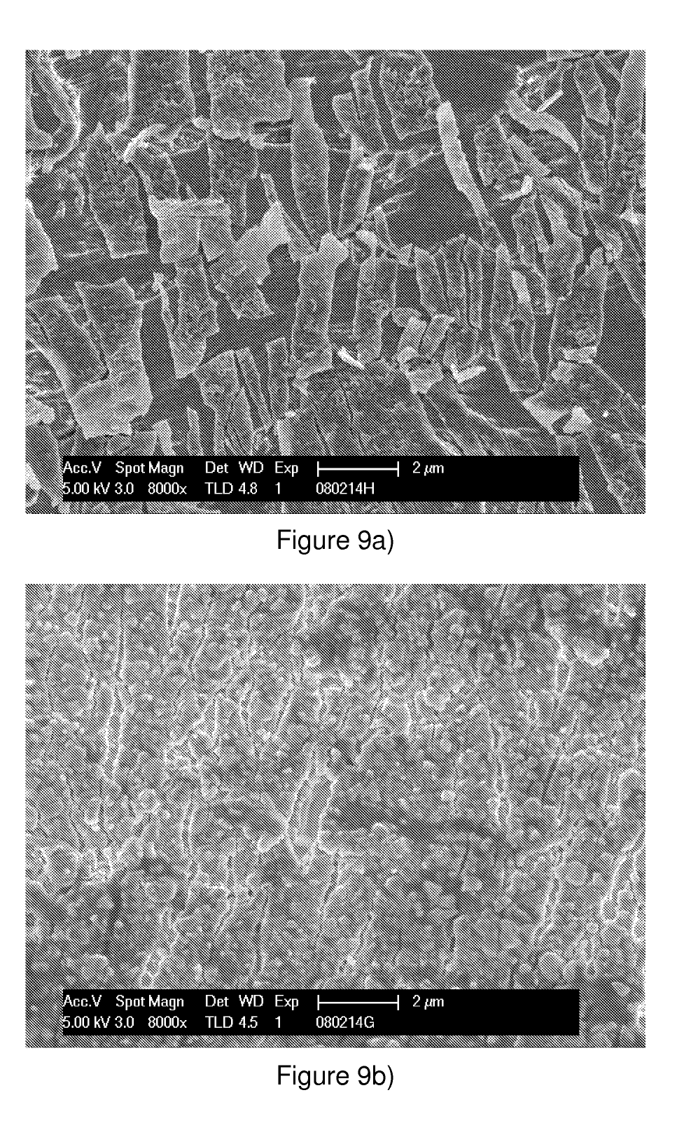

FIG. 9a) respectively FIG. 9b) are micrographs of the two samples that were used to draw the graphs in FIG. 8a) respectively FIG. 8b). We are on the right hand side of the curve. The surface strain on both pictures is around 30%. In both cases delamination has started. One can clearly observe the distance between two cracks. For the first sample (treated at 620° C., FIG. 9a)) the distance is about 1000 nm. For the second sample (treated at 805° C., FIG. 9b)) the distance is about 700 nm. This distance is given both by the adhesion of the coating to the substrate as well as by the capability of the coating to be deformed. This has been discussed above.

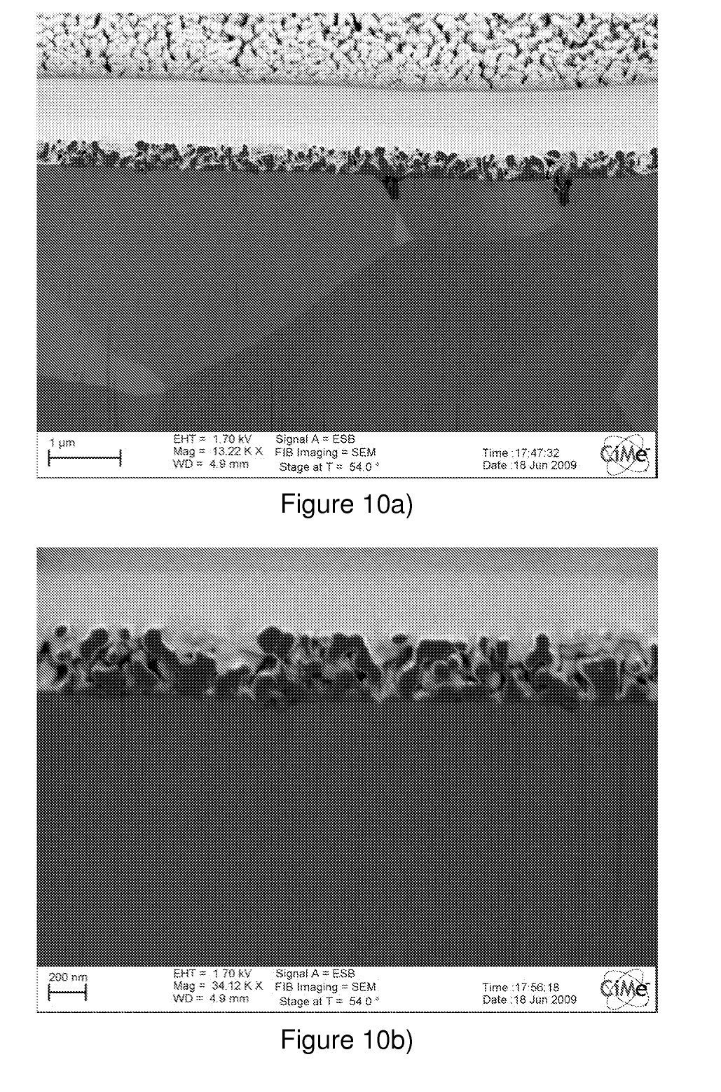

FIG. 10a) and FIG. 10b) show a cross section at two different magnifications of a coating as described in this invention. One can see a 400 nm layer of titanium dioxide deposited onto a stainless steel substrate. The system was then covered with a platinum layer in order to do the cross section. Both figures show the system after deformation. A strain of about 30% has been applied to the substrate in the plane of the picture. One can distinguish small vertical cracks that were formed during deformation. One can also clearly distinguish the domains of coating (having in that embodiment a diameter of about 400 nm) that adhere to the substrate.

1. Element comprising a substrate and a nanoporous adherent coating made of at least one layer, said layer being in adherent contact with said substrate and comprising separate domains of nanoparticles, each of said domains having an average diameter between 1 and 1000 nm and being separated from its neighbor domains on the major part of its circumference by an average distance equal or less to its diameter.

2. Element according to claim 1 wherein the nanoparticles have an average diameter between 1 and 100 nm.

3. Element according to claim 1 wherein the domains have an average diameter between 100 and 800 nm.

4. Element according to claim 1 wherein the average distance separating two neighbor domains is between 20 and 200 nm.

5. Element according to claim 1 wherein the average diameter of the domains is at least five times larger than the average distance between two neighbor domains.

6. Element according to claim 1 wherein said substrate is a metal.

7. Element according to claim 1 wherein said coating is a ceramic.

8. Element according to claim 1 wherein the domains are themselves nanoparticles obtained by sintering and/or fusion of several smaller nanoparticles.

9. Element according to claim 1 wherein said layer is covered by at least one additional layer of nanoparticle clusters which are connected to each other, each connection between two clusters having an average cross-section which is smaller than the diameter of the said two clusters.

10. Element comprising a substrate and a nanoporous adherent coating being made of at least one adherent layer of domains of coating having each an average diameter between 1 and 1000 nm, said element being obtained by the following process:
providing a substrate
depositing on said substrate said coating from a suspension containing nanoparticles with an average diameter between 1 and 500 nm, said coating containing at least a binding agent that is designed to be eliminated during a fixating treatment.
applying a fixating treatment.

11. Element according to claim 10 wherein said nanoparticles are made of ceramic.

12. Element according to claim 10 wherein said fixating treatment is a heat treatment.

13. Element according to claim 10 wherein the heat treatment is characterized by the fact that it is split into at least two sub-treatments, one being conducted in an oxidizing atmosphere and another one being conducted in an inert or reducing atmosphere.

14. Element according to claim 10 wherein the last two steps (nanoparticles deposition and heat treatment) are repeated at least once during the manufacturing process.

15. Element according to claim 10 wherein the binding agent represent at least 5% in mass of the suspension.

16. Element according to claim 10 wherein the binding agent is a polymer such as Polyacrylate, Polyvinylalcohol, Polyethylenglycol or PMMA.

17. Element according to claim 10 wherein the substrate is a metal and the heat treatment step corresponds to the annealing of the substrate.

18. Element according to claim 10 wherein the heat treatment conducted in an oxidizing atmosphere is used to burn organic components and the heat treatment conducted in an inert or reducing atmosphere is used to sinter the material.

19. Element according to claim 10 wherein the inert atmosphere has a maximum partial pressure of oxidizing gas of 10⁻¹⁴ bar.

20. Element according to claim 10 wherein the heat treatment conducted in an oxidizing atmosphere is done at a temperature between 240° C. and 600° C.

21. Element according to claim 10 wherein the heat treatment conducted in an inert or reducing atmosphere is done at a temperature above 500° C.

22. Element according to claim 10 wherein the heat treatment conducted in an inert or reducing atmosphere is done at a temperature below 1000° C.

23. Element according to claim 10 wherein the inert or reducing atmosphere is made of argon, helium, nitrogen, formiergas, hydrogen or a mixture of theses gases.

24. Element according to claim 10 wherein said element is placed in a sealed container for the heat treatment conducted in an inert or reducing atmosphere.

25. Process for manufacturing an element comprising a substrate and a nanoporous adherent coating characterized by the following steps:
providing a substrate
depositing on said substrate said coating from a suspension containing nanoparticles with an average diameter between 1 and 500 nm, said coating containing at least a binding agent that is designed to be eliminated during a fixating treatment.
applying a fixating treatment.
characterized by the fact that it contains a binding agent that will be eliminated during the fixating treatment.

26. Process according to claim 25 wherein said nanoparticles are made of ceramic.

27. Process according to claim 25 wherein said fixating treatment is a heat treatment.
